(19) United States
(12) Patent Application Publication
(10) Pub. No.: US 2002/0099893 A1
(43) Pub. Date: Jul. 25, 2002

(54) System and method for the handling of system management interrupts in a multiprocessor computer system

(76) Inventors: Tuyet-Huong Thi Nguyen, Austin, TX (US); George Mathew, Austin, TX (US); Wai-Ming Richard Chan, Austin, TX (US); Mukund P. Khatri, Austin, TX (US)

Correspondence Address: Roger Fulghum, Baker & Butts, L.L.P., One Shell Plaza, 910 Louisiana, Houston, TX, 77002-4995, US

(21) Appl. No.: 09/768,665

(22) Filed: Jan. 24, 2001

(51) Int. Cl. G06F 13/24

(52) U.S. Cl. 710/260

(57) ABSTRACT

A method for handling system management interrupts in multiprocessors systems is provided. After the processors of the system enter system management mode, one of the processors of the system is designated to handle the system management interrupt. The processor designated to handle the system management interrupt scans a memory location that includes a memory space associated with the saved contents of the processor registers of each processor. After locating a SMI signature in one of the memory spaces associated with the respective processors of the system, the SMI handler of the processor designated to handle the system management interrupts, retrieves any necessary parameters for the system management interrupt from the memory space associated with the SMI signature, thereby allowing a processor to cause the issuance a SMI, to pass a set of parameters for the software SMI, and to permit a second processor to receive the parameters and handle the software SMI.

### TECHNICAL FIELD OF THE INVENTION

The present disclosure relates generally to computer systems and, more particularly, to a system and method for managing system management interrupts in a multiprocessor computer system.

### BACKGROUND OF THE INVENTION

A computer system generally includes various system components that are coupled together using one or more interconnected buses. As an example, a computer system may include a processor that is coupled to a processor bus or host bus. In the case of multiprocessor computer systems, two or more processors may be coupled to the processor bus. Also coupled to the processor bus are a memory controller bridge, which couples the processor bus to system memory, and a PCI bridge, which couples the processor bus to the PCI bus of the computer system. An expansion bridge, sometimes referred to as a south bridge, couples the PCI bus to an expansion bus, such as the ISA bus. The south bridge also serves as a connection point for USB devices and an IDE bus and typically includes an interrupt controller. Memory and expansion devices may be coupled along the PCI bus and the expansion bus.

The processor architecture of a computer system will typically support several types of interrupts. An interrupt is a notification given to the processor that causes the processor to halt the execution of operating code and handle an operating condition that has arisen in the system or in one of the system's external devices. As an example, when a key is pressed on the keyboard, an interrupt is passed to the processor from the peripheral controller asking that the processor stop its current execution stream and receive data from the peripheral controller. Another type of interrupt is a system management interrupt (SMI). A system management interrupt is issued by the expansion bridge or south bridge.

Among other uses, system management interrupts have been used as a power management tool. In portable computer systems, battery life is finite. In many portable computer systems, when there has been no system activity for a defined period of time, a portable computer system may place itself in a reduced power state. When a key on the keyboard is pressed or the mouse is moved, a system management interrupt is issued, instructing the processor that an event has occurred that should cause the computer to exit the reduced power state. System management interrupts may also be initiated through software. These types of interrupts are often referred to as software system management interrupts. As an example, an application executing on the processor can include a piece of code that will cause the processor to write to a particular I/O port of the PCI bridge or the expansion bridge that will in turn cause the PCI bridge or the expansion bridge to issue a system management interrupt. Thus, by executing software that includes an instruction calling for a write to a specific I/O port of the chip set, a software system management interrupt is generated. Causing a system management interrupt to issue through a software instruction is advantageous in that the system management interrupt places the processor in a state in which it is able to operate independently of the operating system, thereby allowing the processor to conduct operations that are not governed by the operating system.

When a system management interrupt is issued to the processor, the processor enters system management mode. In a multiple processor environment, because every processor receives the system management interrupt, each of the processors of the computer system will enter system management mode. As part of system management mode, each processor of the system is allocated a memory block of RAM. This memory space is known as system management RAM, or SMRAM. Upon entering system management mode, each processor saves the contents of its registers to its SMRAM space. In addition to the contents of each processor's registers, the contents of SMRAM will also include the operating code used by each processor's SMI handler.

Placing the processor in system management mode frees the process from the exclusive control of the operating system. Because the processor is able to operate independently of the operating system, privileged level functions of the processor, including some memory and I/O functions, are no longer under the exclusive control of the operating system. As a result, some processor level functions can be manipulated by the application program by invoking the processor's system management mode and the routines of the SMI handler of the processor. Parameters for the SMI routines are passed from the application program to the SMI handler of the processor by saving the parameters to the registers of the processor. In the case of a single processor computer system, the application program will save the SMI routine parameters to one or more of the processor registers of the processor. The processor will next execute a command supplied by the application program that causes the processor to write to the SMI initiator I/O port of the chip set. The chip set will issue a system management interrupt, causing the processor to enter system management mode and save the contents of its registers to the processor's SMRAM space. The processor's SMI handler is then initiated and, using the SMI parameters that were saved to the processor's SMRAM space, executes the functions called for by the interrupt.

A difficulty arises, however, in the case of multiprocessor systems. If an application program attempts to pass parameters to the SMI handler using the registers of a processor, it is not a certainty that the processor that is executing the application will be the processor selected for the handling of the system management interrupt. For example, if parameters are passed in the registers of the first processor, the register contents will be saved to the SMRAM space of the first processor. If a second processor, however, is selected for the handling of the system management interrupt, the second processor will look to its SMRAM space for the passed parameters. The parameters retrieved by the SMI handler in this case will be spurious and the SMI handler will likely not reach the result intended by the application program that caused the issuance of the system management interrupt.

### SUMMARY OF THE INVENTION

In accordance with the present disclosure, a method and system is provided for handling system management interrupts in a multiprocessor computer system. A processor may execute an instruction that initiates a software system management interrupt. In one embodiment of the present invention, a processor may write to a specific port of the chip set of the computer system. The chip set may then issue a system management interrupt, causing all of the processors of the system to enter system management mode. The processor that issued the instruction writes a SMI signature to a predefined register. Upon entering system management mode, the contents of the registers of each of the processors are saved to a memory location. The memory location is partitioned such that each processor has a defined memory space for storage of its register contents. The processor that is selected to handle the system management interrupt scans the memory location for the SMI signature. Upon locating the SMI signature, the processor selected to handle the system management interrupt receives parameters for the system management interrupt from the memory space of the processor associated with the SMI signature. In this manner, the processor that has been selected to handle the system management interrupt can identify the processor that caused the issuance of the system management interrupt and receive parameters passed in the registers of the SMI-initiating processor.

The system management interrupt handling technique disclosed herein is advantageous in that in multiprocessor systems, parameters may be passed to interrupt handlers through the registers of a processor without regard to the identity of the processor that is designated as handling the system management interrupt. Therefore, any processor seeking to perform a function outside of the control of the operating system, can cause the issuance of a system management interrupt and pass to the SMI handler the necessary parameters even if the SMI-initiating processor is not the processor later selected for the handling of the system management interrupt. This technique thus removes the potential disconnect inherent in all multiprocessor systems in which a processor is able to issue a software SMI, but, because of uncertainty concerning the processor that is to actually handle the system management interrupt, no parameters may be passed to the SMI handler. According to the presently disclosed methods, parameters may be passed to the SMI handler regardless of its location among the processors of the computer system.

Another technical advantage of the present disclosure is a method for handling system management interrupts in multiprocessor systems in which only one or a subset of the processors includes an SMI handler. The processors that do not include an SMI handler can pass parameters to a processor that includes an SMI handler. The parameters of a processor that does not include an SMI handler are passed through the processor's SMRAM memory space. The processor designated for handling the system management interrupt reads in these parameters from the SMRAM space once it has located the SMI signature saved to the SMRAM space by the processor initiating the system management interrupt. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of the architecture of a multiprocessor computer system;

FIG. 2 is a flow diagram of the process of handling a software system management interrupt; and

FIG. 3 is a diagram of the system management RAM memory space.

### DETAILED DESCRIPTION OF THE INVENTION

The present disclosure concerns a method and system for managing the handling of system management interrupts in a multiprocessor computer system. The method and system described herein is especially applicable in multiprocessor computer systems in those instances in which an application stores data to a register of a processor and then issues an instruction that causes the initiation of a software system management interrupt.

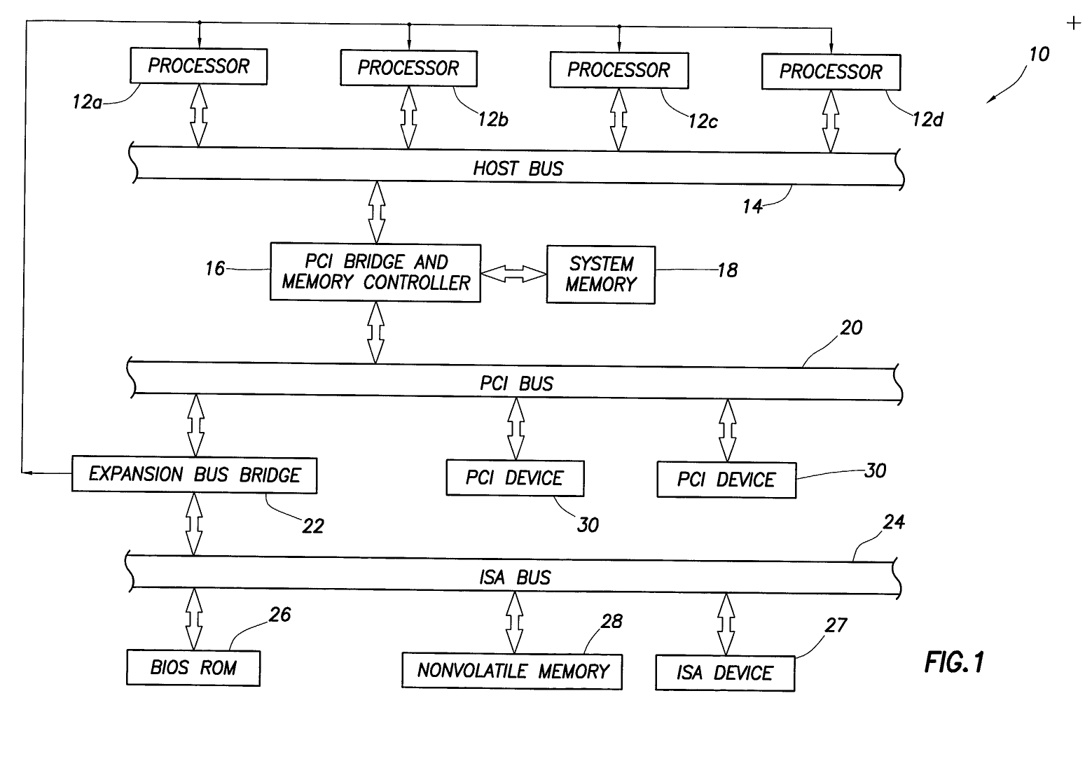

Shown in FIG. 1 is a schematic block diagram of a computer system, which is indicated generally at 10. Computer system 10 is a multiprocessor computer system and includes processors 12a, 12b, 12c, and 12d, each of which is coupled to host bus 14. Also coupled to host bus 14 is a memory controller and PCI bridge 16, which is also coupled to system memory 18 and a PCI bus 20. Coupled to PCI bus 20 are a number of PCI devices 30. Coupled to PCI bus 20 is an expansion bus bridge 22, which is coupled to expansion bus 24. As is common in some modem computer systems, expansion bus 24 may be an ISA bus, and expansion bridge 22 may be a PCI/ISA bridge. As an alternative, expansion bus 24 and expansion bridge 22 may operate according to another suitable expansion bus standard. Coupled to expansion bus 24 are a BIOS ROM 26, nonvolatile memory 28, and a number of ISA or expansion devices 27. Nonvolatile memory 28 may be an NVRAM or a CMOS memory.

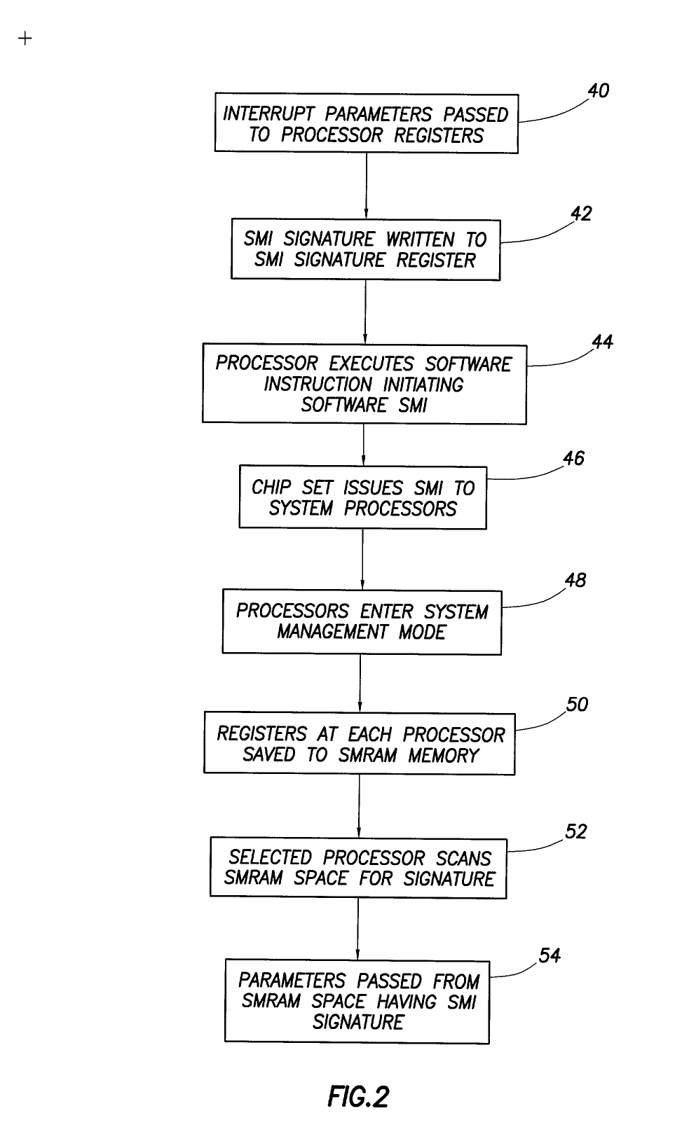

Shown in FIG. 2 is a flow diagram of the process of handling a software SMI of the present disclosure. Prior to issuing a software SMI, at step 40, the application program that is being run on one of the processors 12 performs a parameter passing function by writing the parameters of the SMI to one or more of the registers of the processor. At step 42, the application program writes a unique software SMI signature to a register of the processor that is currently running the application program. At step 44, the processor issues the software instruction that causes the initiation of the system management interrupt. In most instances, the software instruction executed by the processor is a write to a defined I/O port of the chip set, specifically a write to an I/O port of the PCI bridge 16 or the expansion bridge or south bridge 22. At step 46, the chip set receives the I/O write that was initiated by one of the processor and initiates the system management interrupt. In the system diagram of FIG. 1, the ISA or expansion bridge 22 is shown as logically coupled to each of processors 12 for the delivery of the system management interrupt to each of processors 12. In summary, the application program that is being executed by a processor of the computer system may include an instruction that when executed by the processor causes the processor to write to a port of the chip set that in turn causes the chip set to issue a software SMI, causing all of the processor of the system to enter system management mode (step 48).

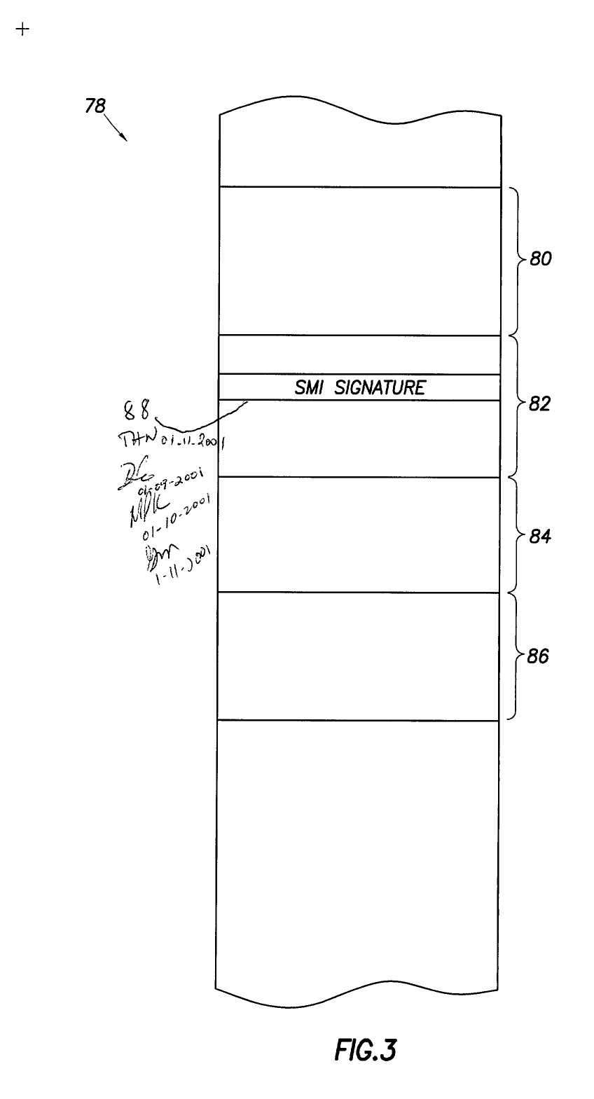

The system management interrupt is delivered by expansion bridge 22 to each of the processors 12. At step 50, the processor context of each processor, i.e., the content of each processor's registers, is saved to each processor's respective S space. The processor that has been designated as the SMI handler scans at step 52 the SMRAM space of each processor, searching for the software SMI signature. The processor not selected for handling the SMI will cycle until the handling of the SMI is complete. Shown in FIG. 3 is a diagram of the SMRAM memory space 78 for a computer system having four processors. Processor 12a, 12b, 12c, and 12d are allocated SMRM memory spaces 80, 82, 84, and 86, respectively. In one example, processor 12b is the processor that issued the software instruction that caused the issuance of the software SMI. The software SMI signature is saved to the SMRAM space 82 associated with processor 12b. In this example, processor 12c has been selected as the processor whose SMI handler will address the software SMI. Once processor 12c locates the software SMI signature 88, which in this example is in the SMRAM space 82 associated with processor 12b, the SMI handler of processor 12c uses the parameters that have been passed to the SMRAM that includes software SMI signature. The parameter passing step 54 of FIG. 2 is accomplished through the SMRAM space of the processor that caused the initiation of the software SMI, without regard to the processor that is selected by the BIOS of the computer system to handle the software SMI.

In some cases, only one of the processors of a multiprocessor system is designated as being the processor that handles all system management interrupts. In this scenario, only one processor of the computer system, the SMI processor, will include a SMI handler and the responsibility for handling all system management interrupts will be passed to this processor. The disclosed method of parameter passing and initiation of software system management interrupts in multiprocessor systems is advantageous in those computer systems in which only one of the system processor is designated to handle all system management interrupts. Regardless of the processor identity of the processor that caused the issuance of the software SMI, the system management interrupt can be handled through the single processor of the computer system that includes the SMI handler.

The present disclosure describes a method for handling parameter passing for software system management interrupts in multiprocessor computer systems. By implementing the system of the present disclosure in multiprocessor systems, a software SMI can be issued and the parameters of the SMI can be passed without regard to the selection of a particular processor for the handling of the software system management interrupt. Moreover, in those multiprocessor systems in which one of the processors is designated to handle all software system management interrupts, parameters can be passed and a software system management interrupt can be issued by any of the processors of the system. In either scenario, once the processor selected to handle the system management interrupt locates the SMI signature in SMRAM, the SMI handler uses the register contents saved in the SMRAM space associated with the SMI signature.

Although the present disclosure has been described in detail, it should be understood that various changes, substitutions, and alterations can be made hereto without departing from the spirit and the scope of the invention as defined by the appended claims.

What is claimed is:

1. A method for handling system management interrupts in a multiprocessor computer system, comprising the steps of:
writing a predetermined signature to a predetermined register of the first processor;
executing in a first processor a command of a software application to cause the first processor to initiate a system management interrupt;
receiving at each processor an instruction that a software system management interrupt has been issued;
entering system management mode at each processor;
saving the register contents of each processor to a memory space associated with each respective processor;
selecting a second processor as the system management interrupt handler;
scanning the contents of the memory space associated with each processor; and
when the second processor locates the saved predetermined signature in one of the memory spaces associated with the processors of the computers system, using the contents of the memory space associated with the predetermined signature for any parameters necessary for the handling of the system management interrupt.

2. The method for issuing and handling system management interrupts in a multiprocessor computer system of claim 1, wherein the step of selecting a second processor as the system management interrupt handler comprises the step of selecting a second processor as the system management interrupt handler according to an arbitration scheme.

3. The method for issuing and handling system management interrupts in a multiprocessor computer system of claim 2, wherein the arbitration scheme is a round robin scheme in which the responsibility for handling the system management interrupt is assigned to each processor in turn.

4. The method for issuing and handling system management interrupts in a multiprocessor computer system of claim 1, wherein the first processor and the second processor are the same processor.

5. The method for issuing and handling system management interrupts in a multiprocessor computer system of claim 1, wherein the step of executing in a first processor a command of a software application to cause the first processor to initiate a system management interrupt comprises the step of executing a software instruction causing to the processor to write to a predetermined port of the chip set of the computer system.

6. The method for issuing and handling system management interrupts in a multiprocessor computer system of claim 5, wherein the predetermined port of the chip set resides in the PCI bridge of the chip set.

7. The method for issuing and handling system management interrupts in a multiprocessor computer system of claim 5, wherein the predetermined port of the chip set resides in the expansion bridge of the chip set.

8. The method for issuing and handling system management interrupts in a multiprocessor computer system of claim 7, further comprising the step of issuing from the expansion bridge an instruction causing each of the processors of the system to enter system management mode.

9. A computer system, comprising:
a first processor;
a second processor;
a chip set, the chip set including a bus bridge coupling a first bus of a first format to a second bus of a second format;
a memory having a memory space reserved for each processor of the computer system, the reserved memory space being used for the storage of the contents of the register of each processor in the event that a processor of the computer system enters system management mode; and
wherein each of the processors is capable of issuing an instruction causing the issuance of a system management interrupt and thereby causing each of the processors to receive from the chip set a system management interrupt, and, in the case of the processor selected for the handling of the interrupt, scanning the memory space to locate a signature issued by the processor initiating the software system management interrupt to permit the selected processor to locate the parameters passed by the processor that issued the instruction that caused the issuance of the system management interrupt.

10. The computer system of claim 9, wherein the instruction issued by the processor is a write instruction.

11. The computer system of claim 10,
wherein the write instruction is received by the chip set of the computer system; and
wherein the chip set of the computer system issues the instruction that causes the processors of the system to enter system management mode.

12. The computer system of claim 11, wherein the write instruction is received at the PCI bridge of the chip set.

13. The computer system of claim 11, wherein the write instruction is received at the expansion bus bridge of the chip set.

14. The computer system of claim 9, wherein each processor includes a predetermined register for receiving a data signature indicating that the processor of the register caused the issuance of a software system management interrupt.

15. The computer system of claim 14, wherein the data signature is saved to the memory space reserved for the processor of the register and identifies the processor that issued the instruction that caused the issuance of the system management interrupt.

16. A method for handling system management interrupts in a multiprocessor computer system in which less than all of the processors of the computer system have been designated for the handling of software system management interrupts, comprising the steps of:
issuing an instruction from a first processor of the system to a chip set of the computer system;
receiving the instruction at the chip set of the computer system and, in response, issuing a command causing the processors of the system to enter system management mode;
writing a software system management interrupt signature to a predetermined register of the first processor as an indication that the first processor issued the command that caused the processors of the system to enter system management mode;
writing the content of the registers of each processor to a memory location, the memory location including a memory space reserved for and associated with the register contents of each processor;
transmitting a software system management interrupt to a second processor of the computer system, the second processor including a system management interrupt handler, and the second processor locating, in response, to the receipt of the software system management interrupt the software system management interrupt signature in the memory location; and
retrieving for use by the system management interrupt handler as parameters register contents saved by the first processor to the memory space associated with the software system management interrupt.

17. The method for handling system management interrupts in a multiprocessor computer system of claim 16 wherein the first processor does not include a system management interrupt handler.

18. The method for handling system management interrupts in a multiprocessor computer system of claim 16 wherein only the second processor includes a system management interrupt handler.

19. The method for handling system management interrupts in a multiprocessor computer system of claim 16 wherein the instruction from the first processor to the chip set of the computer system is a write command to a predetermined port of the chip set.

20. The method for handling system management interrupts in a multiprocessor computer system of claim 19 wherein the write command is received and the software system management interrupt is issued by the PCI bridge of the chip set.

21. The method for handling system management interrupts in a multiprocessor computer system of claim 19 wherein the write command is received and the software system management interrupt is issued by the expansion bus bridge of the chip set.

22. A method for handling system management interrupts in a multiprocessor computer system, comprising the steps of:
receiving at one of the processors of the computer system a system management interrupt;
scanning the memory location containing the saved context of each processor of the computer system;
locating in the memory location a signature identifying the saved context of the processor that issued the instruction that caused the system management interrupt; and
retrieving from the saved context of the processor the parameters necessary for the handling of the system management interrupt.

23. The method for handling system management interrupts in a multiprocessor system of claim 22, wherein the processor that received the system management interrupt is not the same as the processor that issued the instruction that caused the system management interrupt.

24. The method for handling system management interrupts in a multiprocessor system of claim 23, wherein the instruction that caused the system management interrupt is a write instruction to a predetermined port in the chip set of the computer system.

25. The method for handling system management interrupts in a multiprocessor system of claim 24, wherein the write instruction is received at a predetermined port of the PCI bridge of the computer system.

26. The method for handling system management interrupts in a multiprocessor system of claim 25, wherein the write instruction is received at a predetermined port of the expansion bus bridge of the computer system.

27. The method for handling system management interrupts in a multiprocessor system of claim 26,
wherein the processor that receives the system management interrupt includes a system management interrupt handler; and
wherein the processor that issued the instruction that caused the system management interrupt has not been designated for the hanlding of system management interrupts.
